(19) United States
(12) Patent Application Publication
(10) Pub. No.: US 2014/0065900 A1
(43) Pub. Date: Mar. 6, 2014

(54) WATERPROOF ELEMENT WITH REINFORCED STRUCTURE AND ELECTRONIC DEVICE

(71) Applicant: ASKEY COMPUTER CORP., New Taipei City (TW)

(72) Inventor: Po-Sheng Wang, New Taipei City (TW)

(73) Assignee: ASKEY COMPUTER CORP., New Taipei City (TW)

(21) Appl. No.: 13/664,094

(22) Filed: Oct. 30, 2012

(30) Foreign Application Priority Data
Aug. 31, 2012 (TW) 101216879

(51) Int. Cl. H01R 13/46; B32B 1/06

(52) U.S. Cl. 439/892; 428/34.1

(57) ABSTRACT

A waterproof element with reinforced structure includes a flexible body and a rigid element. The flexible body has a first opening. The rigid element is disposed in the flexible body. The rigid element has a second opening corresponding to the first opening. An electronic device with the waterproof element is also disclosed.

### CROSS REFERENCE TO RELATED APPLICATIONS

This Non-provisional application claims priority under 35 U.S.C. §119(a) on Patent Application No(s). 101216879 filed in Taiwan, Republic of China on Aug. 31, 2012, the entire contents of which are hereby incorporated by reference.

### BACKGROUND OF THE INVENTION

1. Field of Invention

The invention relates to a waterproof element and, in particular, to a waterproof element with reinforced structure and an electronic device with the waterproof element.

2. Related Art

With the improved technology, the electronic device, such as a smart phone, a tablet computer, or a notebook, is configured with several sockets for fitting several standards of the transmission plugs. For example, a smart phone may have an HDMI (High Definition Multimedia Interface) socket, a USB (Universal Serial Bus) socket or a sound output socket. For electrically connecting to the plugs, they are usually made of metal, such as iron. However, some problems related to the metal-made socket must occur. For example, a short circuit will occur when water enters into the socket, or the metal of the socket will be oxidized when the socket contacts water and air.

In the conventional art, for solving the problem of the short circuit or oxidization, a cover body is detachably disposed to cover the socket so as to prevent the socket from contacting water. However, the cover body is usually made of soft material, such as rubber, so when the cover body is pulled or dragged, it may fall off or be displaced, being unable to effectively cover the socket any more and losing the waterproof function. Besides, although the cover body can be strengthened by coinjection molding, two molds need to be used in the process, thus raising the cost a lot.

Therefore, it is an important subject to provide a waterproof element that is not only waterproof but also can resist the dragging force so as not to fall off or be displaced.

### SUMMARY OF THE INVENTION

In view of the foregoing subject, an objective of the invention is to provide a waterproof element that is not only waterproof but also can resist the dragging force so as not to fall off or be displaced.

To achieve the above objective, a waterproof element with reinforced structure of the invention comprises a flexible body and a rigid element. The flexible body has a first opening. The rigid element is disposed in the flexible body and has a second opening corresponding to the first opening.

In one embodiment, the rigid element comprises at least a positioning opening.

In one embodiment, the rigid element comprises at least a connection opening.

In one embodiment, when the rigid element has a plurality of positioning openings, they are disposed around the second opening symmetrically.

In one embodiment, a surface of the rigid element is a rough surface.

In one embodiment, each of the forms of the first opening and the second opening is an ellipse or a rectangle.

To achieve the above objective, an electronic device of the invention comprises a device body and at least one waterproof element. The device body comprises at least one socket. The waterproof element is disposed to the device body corresponding to the socket. The waterproof element comprises a flexible body having a first opening, and a rigid element disposed in the flexible body and having a second opening corresponding to the first opening.

In one embodiment, the rigid element comprises at least a positioning opening.

In one embodiment, the rigid element comprises at least a connection opening.

In one embodiment, when the rigid element has a plurality of positioning openings, they are disposed around the second opening symmetrically.

In one embodiment, a surface of the rigid element is a rough surface.

In one embodiment, each of the forms of the first opening and the second opening is an ellipse or a rectangle.

As mentioned above, the waterproof element with reinforced structure includes a flexible body and a rigid element disposed in the flexible body, so the electronic device using the waterproof element is configured with the waterproof function. Besides, the waterproof element can sustain the dragging force and will not be easily loosed or moved, thereby improving the quality of the electronic device.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a waterproof element with reinforced structure of a preferred embodiment of the invention;

FIGS. 2A to 2D are schematic diagrams of different rigid elements of the preferred embodiment of the invention;

FIG. 3A is a schematic diagram of an electronic device of a preferred embodiment of the invention;

FIG. 3B is an exploded diagram of an electronic device of a preferred embodiment of the invention; and

FIG. 3C is a sectional diagram of an electronic device of a preferred embodiment of the invention.

### DETAILED DESCRIPTION OF THE INVENTION

The present invention will be apparent from the following detailed description, which proceeds with reference to the accompanying drawings, wherein the same references relate to the same elements.

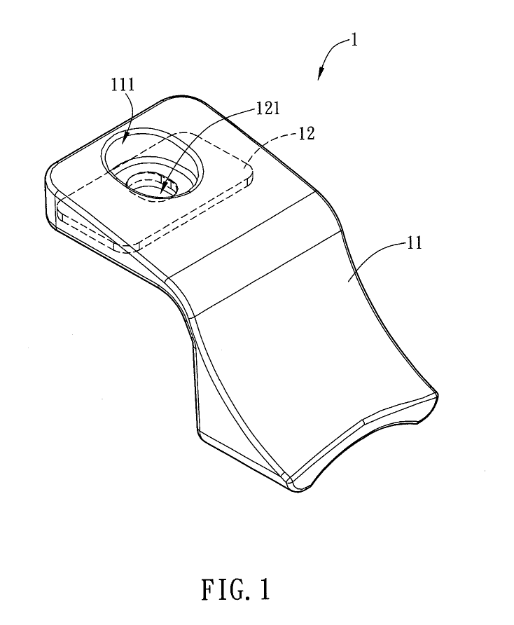

FIG. 1 is a schematic diagram of a waterproof element with reinforced structure of a preferred embodiment of the invention. The waterproof element 1 includes a flexible body 11 and a rigid element 12.

The flexible body 11 has a first opening 111. The material of the flexible body 11 is capable of flexibility and waterproof property. The material of the flexible body 11 is rubber or silicon resin for example, with a hardness value about 50. To be noted, the shape or size of the flexible body 11 as shown in FIG. 1 is just for example, and can be changed according to the practical requirements.

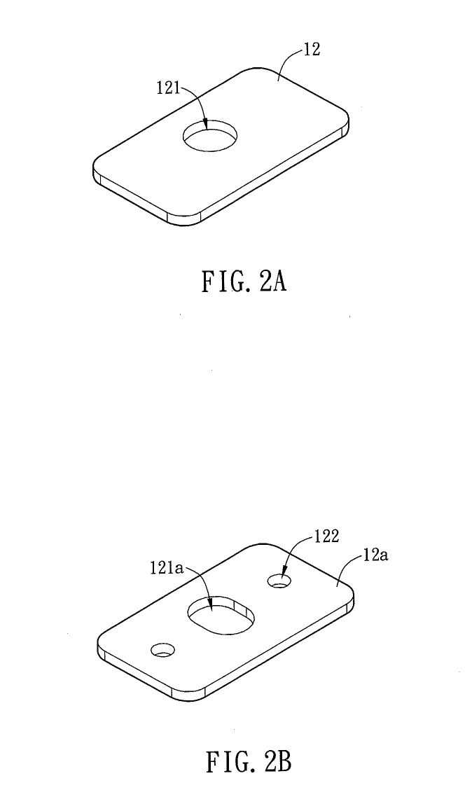

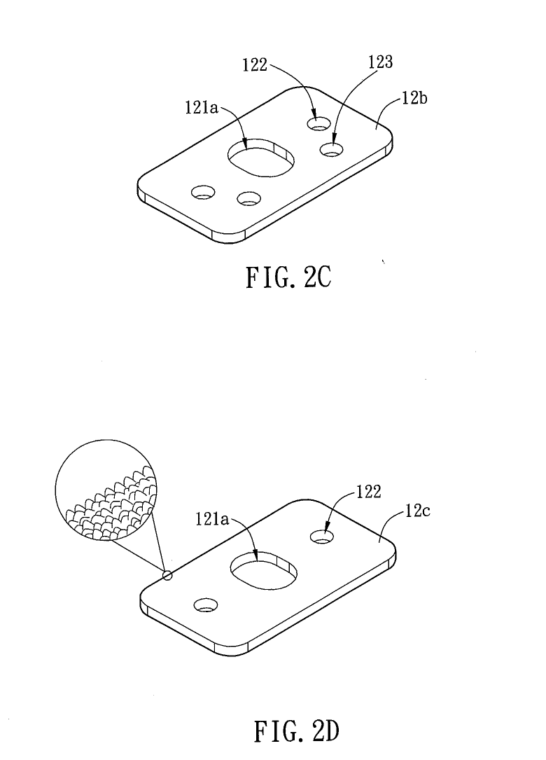

The rigid element 12 is disposed in the flexible body 11. The material of the rigid element 12 is, for example, iron, nickel, stainless steel, or alloy. The hardness of the rigid element 12 is larger than that of the flexible body 11 to complement the structural strength of the flexible body 11 for reinforcing the whole structure of the waterproof element 1. FIG. 2A is a schematic diagram of the rigid element 12. In the embodiment, the rigid element 12 has a second opening 121 that is disposed corresponding to the first opening 111 and, for example, overlapped with the first opening 111.

During the manufacturing process, the material of the flexible body 11 is melted and injected into a mold holding the rigid element 12, and then the waterproof element 1 is formed as one piece after the material of the flexible body 11 is cooled. To be noted, the above-mentioned manufacturing method of the waterproof element is just for example, and not for limiting the scope of the invention.

FIGS. 2B to 2D are schematic diagrams of different rigid elements of the preferred embodiment of the invention. As shown in FIG. 2B, different from the rigid element 12, the rigid element 12a further includes two positioning openings 122. When the rigid element 12a is put into a mold, the positioning openings 122 thereof can be connected with the corresponding two positioning pillars so that the rigid element 12a can be fixed into the mold firmly. Accordingly, the rigid element 12a will not be displaced by the pressure or impact caused by the injection of the melted material of the flexible body 11. To deserve to be mentioned, the second opening 121a also can provide the positioning effect. Therefore, if the positioning openings 122 are plural, they are preferably disposed around the second opening 121a symmetrically. Of course, the number and the shape of the positioning openings 122 can be changed according to the practical applications.

The second opening 121 as shown in FIG. 2A is a circular form, and the second opening 121a is an elliptic form. The second opening 121a may have some error in size due to some reason, for example, the inaccuracy of the machine, so that the assembly can not be conducted successfully. In order to avoid the above-mentioned problem, the form of the second opening 121a is designed as an ellipse so as to provide some error tolerance. Of course, the second opening 121a can be designed as other shapes, such as a rectangular form, according to the practical applications.

As shown in FIG. 2C, different from the rigid element 12a, the rigid element 12b further has two connection openings 123. By the connection openings 123, the rigid element 12b and the flexible body 11 can be connected together more firmly after the material of the flexible body 11 is cooled. Of course, the number and the form of the connection openings 123 can be changed according to the practical applications.

As shown in FIG. 2D, different from the rigid element 12a, the rigid element 12c further has a rough surface. By the rough surface, the rigid element 12c and the flexible body 11 can be connected together more firmly after the material of the flexible body 11 is cooled.

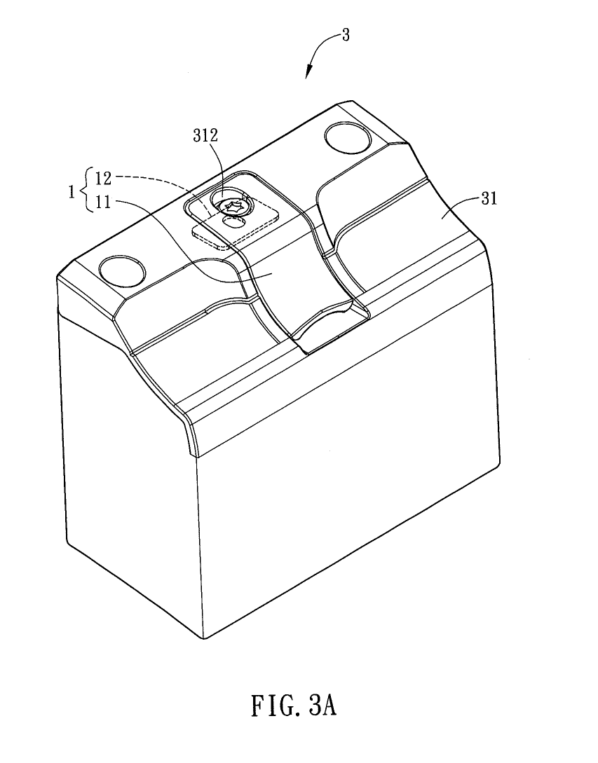

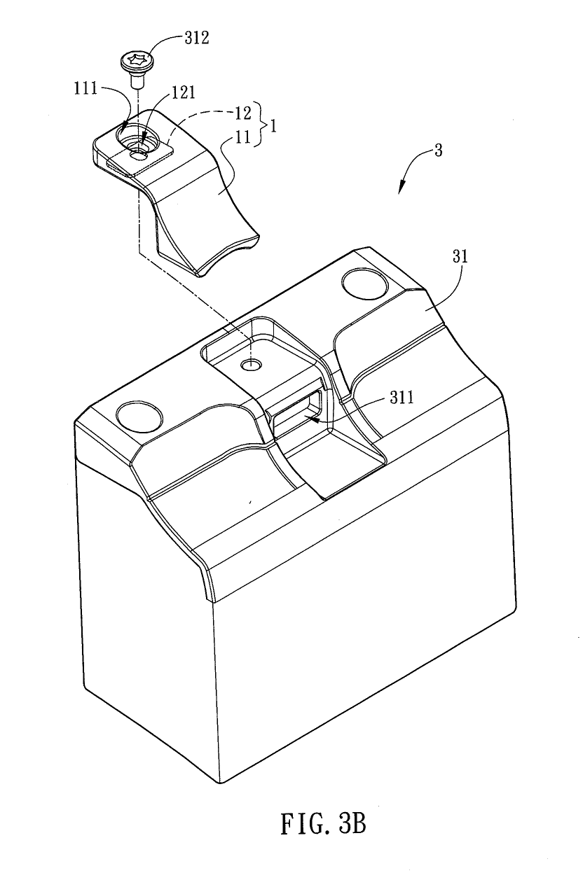

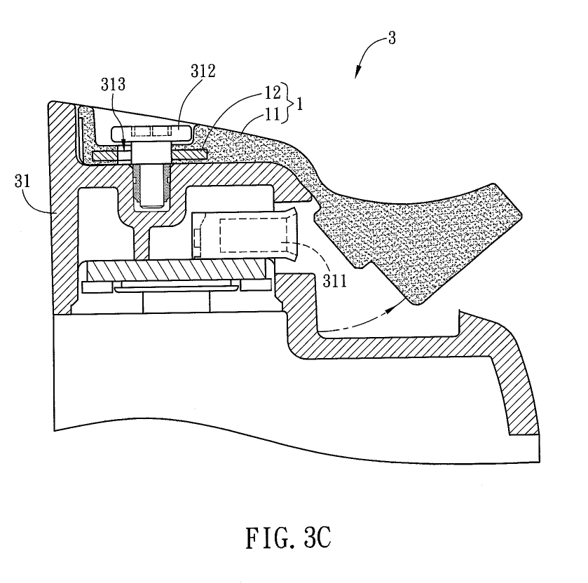

FIG. 3A is a schematic diagram of an electronic device of a preferred embodiment of the invention, and FIG. 3B is an exploded diagram of the electronic device as shown in FIG. 3A. Referring to FIGS. 3A and 3B, the electronic device 3 includes a device body 31 and at least one waterproof element 1.

The device body 31 is, for example, a smart phone body, a tablet computer body, a PDA (Personal Digital Assistant) body, or a notebook body. In the embodiment, the device body 31 includes at least one socket 311, such as a USB (Universal Serial Bus) socket, an HDMI (High Definition Multimedia Interface) socket, or a sound output socket. The material of the socket 311 is iron or other metal, or alloy, etc. Accordingly, the socket 311 will be oxidized when contacting water. Besides, the socket 311 will be short-circuited when water enters into the socket 311, and the electronic device 3 is thus damaged.

The waterproof element 1 is disposed to the device body 31 corresponding to the socket 311. Referring to FIG. 1, the waterproof element 1 includes a flexible body 11 and a rigid element 12.

The flexible body 11 has a first opening 111. The material of the flexible body 11 is capable of flexibility and waterproof property. The material of the flexible body 11 is rubber or silicon resin for example, with a hardness value about 50. To be noted, the shape or size of the flexible body 11 as shown in FIG. 1 is just for example, and can be changed according to the practical requirements.

The rigid element 12 is disposed in the flexible body 11. The material of the rigid element 12 is, for example, iron, nickel, stainless steel, or alloy. The hardness of the rigid element 12 is larger than that of the flexible body 11 to complement the structural strength of the flexible body 11 for reinforcing the whole structure of the waterproof element 1. FIG. 2A is a schematic diagram of the rigid element 12. In the embodiment, the rigid element 12 has a second opening 121 that is disposed corresponding to the first opening 111 and, for example, overlapped with the first opening 111.

Regarding the manufacturing method, the material of the flexible body 11 is melted and injected into a mold holding the rigid element 12, and then the waterproof element 1 is formed as one piece after the material of the flexible body 11 is cooled.

The waterproof element 1 and the device body 31 can be connected together by the first and second openings 111 and 121 and, for example, by locking or wedging. In the embodiment, the waterproof element 1 is locked to the device body 31 by a connection element 312, such as a screw. To be noted, the above-mentioned connection method of the waterproof element 1 and the device body 31 is just for example, and not for limiting the scope of the invention.

FIG. 3C is a sectional diagram of an electronic device of a preferred embodiment of the invention. To deserve to be mentioned, since the flexible body 11 of the waterproof 1 is made by flexible material, the flexible body 11 is capable of flexibility and ductility. Accordingly, when the waterproof element 1 is lifted by an external force, the socket 311 is exposed. Furthermore, the sizes of the first opening 111 and the second opening 121 are a little larger than the size of the connection element 312, so a movement room 313 is formed between the device body 31 and the waterproof element 1, allowing the waterproof element 1 to move a little for the easy lift.

FIGS. 2B to 2D are schematic diagrams of different rigid elements of the preferred embodiment of the invention. As shown in FIG. 2B, different from the rigid element 12, the rigid element 12a further includes two positioning openings 122. When the rigid element 12a is put into a mold, the positioning openings 122 thereof can be connected with the corresponding two positioning pillars so that the rigid element 12a can be fixed into the mold more firmly. Accordingly, the rigid element 12a will not be displaced by the pressure or impact caused by the injection of the melted material of the flexible body 11. To deserve to be mentioned, the second opening 121a also provides the positioning effect. Therefore, if there are plural positioning openings 122, they are preferably disposed around the second opening 121a symmetrically. The number and the shape of the positioning openings 122 can be changed according to the practical applications.

Besides, the second opening 121 is a circular form, and the second opening 121a is an elliptic form. The second opening 121a may have some error in size due to some reason, for example, the inaccuracy of the machine, so that the assembly can not be conducted successfully. In order to avoid the above-mentioned problem, the form of the second opening 121a is designed as an ellipse so as to provide some error tolerance. Of course, the second opening 121a can be designed as other shapes, such as a rectangular form, according to the practical applications.

As shown in FIG. 2C, different from the rigid element 12a, the rigid element 12b further has two connection openings 123. By the connection openings 123, the rigid element 12b and the flexible body 11 can be connected together more firmly after the material of the flexible body 11 is cooled. Of course, the number and the form of the connection openings 123 can be changed according to the practical applications.

As shown in FIG. 2D, different from the rigid element 12a, the rigid element 12c further has a rough surface. By the rough surface, the rigid element 12c and the flexible body 11 can be connected together more firmly after the material of the flexible body 11 covering the rigid element 12a is cooled.

In summary, the waterproof element with reinforced structure includes a flexible body and a rigid element disposed in the flexible body, so the electronic device using the waterproof element is configured with the waterproof function. Besides, the waterproof element can sustain the dragging force and will not be easily loosed or moved, thereby improving the quality of the electronic device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A waterproof element with reinforced structure, comprising:
a flexible body having a first opening; and
a rigid element disposed in the flexible body and having a second opening corresponding to the first opening.

2. The waterproof element as recited in claim 1, wherein the rigid element comprises at least a positioning opening.

3. The waterproof element as recited in claim 2, wherein the positioning openings are disposed around the second opening symmetrically.

4. The waterproof element as recited in claim 1, wherein the rigid element comprises at least a connection opening.

5. The waterproof element as recited in claim 1, wherein a surface of the rigid element is a rough surface.

6. An electronic device, comprising:
a device body comprising at least one socket; and
at least one waterproof element disposed to the device body corresponding to the socket and movably covering or exposing the socket, wherein the waterproof element comprises a flexible body having a first opening, and a rigid element disposed in the flexible body and having a second opening corresponding to the first opening.

7. The electronic device as recited in claim 6, wherein the rigid element comprises at least a positioning opening.

8. The electronic device as recited in claim 7, wherein the positioning openings are disposed around the second opening symmetrically.

9. The electronic device as recited in claim 6, wherein the rigid element comprises at least a connection opening.

10. The electronic device as recited in claim 6, wherein a surface of the rigid element is a rough surface.
